(19) United States
(12) Patent Application Publication
(10) Pub. No.: US 2008/0310651 A1
(43) Pub. Date: Dec. 18, 2008

(54) CIRCUIT AND METHOD FOR ELIMINATING SPEAKER CRACKLE DURING TURNING ON OR OFF POWER AMPLIFIER

(76) Inventor: Jy-Der David TAI, Sanchong City (TW)

Correspondence Address: SINORICA, LLC, 528 FALLSGROVE DRIVE, ROCKVILLE, MD, 20850, US

(21) Appl. No.: 11/836,871

(22) Filed: Aug. 10, 2007

(30) Foreign Application Priority Data
Jun. 15, 2007 (TW) 96121725

(51) Int. Cl. H04B 15/00

(52) U.S. Cl. 381/94.5

(57) ABSTRACT

The present invention discloses a circuit for eliminating speaker crackle during turning on or off a power amplifier and a method for the same, particularly to a circuit and method, wherein an input capacitor is used to pre-charge an output capacitor to reduce speaker crackle to an inaudible level during turning on or off a power amplifier. The present invention has a low cost and a simplified design without the penalty of bandwidth.

### BACKGROUND OF THE INVENTION

1. Field of the Invention

The present invention relates to a circuit for eliminating speaker crackle during turning on or off power amplifier and a method for the same, particularly to a circuit and method, wherein a charging voltage of an input capacitor is used to pre-charge an output capacitor to reduce speaker crackle to an inaudible level during turning on or off a power amplifier.

2. Description of the Related Art

In the digital world nowadays, the usage of speaker is no less than any other electronic elements. Speakers are used in computers, televisions and many other multimedia devices. Moreover, some people do not hesitate to spend a lot in upgrading their speaker systems to achieve better audio quality. However, users often hear cracking noise during turning on or off their speaker-containing electronic devices. A long term speaker crackle may not only damage speakers but also hurt audition.

In conventional methods for overcoming speaker crackle, the amplifier will not output audio signal until the voltages of related capacitors are stabilized. Refer to FIG. 1 for a circuit of a conventional technology. When the power supply is turned on, the voltage of the power supply will rise from zero to Vcc. In this stage, the output capacitor Cout begins to be charged via two voltage-division resistors R. The equation of charging current is

I=(Vcc/R)e^{-t/0.5RCout}.

wherein the initial value (the peak value) of the charging current is Iₚₑₐₖ=V_{cc}/R, and the charging time constant is 0.5RCₒᵤₜ. The charging resistance R is much greater than the resistance of speaker load; therefore, speaker load can be neglected in the preceding equation.

In a common audio amplifier, the low frequency −3 db point is required to be less than 20 Hz. The relationship of the frequency of the low frequency −3 db point, speaker impedance and output capacitance Cout is f_{-3 db}=1/(2πRₛₚₖCₒᵤₜ), wherein Rₛₚₖ denotes speaker impedance. For a 4 ohm speaker, an output capacitance of 200 uF (Cₒᵤₜ=1/(2πRₛₚₖf_{-3 db})=1/(2π×4×20)=200 uF) is needed to meet the requirement of the low frequency −3 db point. Therefore, output capacitance has to reach as high as 2000 uF to solve the problem of bandwidth.

For reducing the peak charging current Iₚₑₐₖ=V_{cc}/R, R should be as great as possible. Suppose the voltage of the power supply is 5V. If the peak current is to be reduced to less than 1 mA, R=V_{cc}/Iₚₑₐₖ=5V/1 mA=5 k ohms. The voltage equation of capacitor charging is

V=Vcc/2(1−e^{-t/0.5RCout}).

If the output capacitor Cout is to be charged to have a voltage of 99% of Vcc/2,

(V_{cc}/2)×99%=V_{cc}/2(1−e^{-t/0.5RCout}), i.e.,

(5V/2)×0.99=5V/2(1−e^{-t/0.5RCount}).

### Thus,

$$\begin{matrix}t = - 0.5 {RC}_{out} \times ln ( 0.01 ) = 2.3 {RC}_{out} \\ = 2.3 \times 5 k ohms \times 2000 uF \\ = 23 seconds .\end{matrix}$$

Consequently, for reducing crackle current to less than 1 mA and reaching 99% of charging voltage, the waiting time must be longer than 23 seconds. However, a rational waiting time should be less than 3-5 seconds. Thus, crackle current will rise to 5-8 mA. Therefore, designers have to compromise between crackle volume and waiting time.

After the waiting time or delay time, the output of the amplifier is turned on, and a voltage of Vcc/2 is sent to Cout. If the delay time is not long enough or Cout voltage is not close to Vcc/2, a second crackle will appear because the voltage of Vcc/2 output by the amplifier will create a great instant charging current to rapidly charge Cout to Vcc/2 compulsively.

In addition to the charging crackle of the output capacitor, the input capacitor also has the problem of charging crackle. Refer to FIG. 2 for a circuit of another conventional technology. The input capacitor Cin is also constrained by the −3 db requirement, wherein f_{-3 db}=½πRᵢₙCᵢₙ. In the schemes proposed by MAXIM Co. (MAX9715, page 8) and Philips Semiconductor (TDA 8932, page 16), the output stage of the amplifier is not turned on until the input charging circuit and the output charging circuit are stabilized. Similar to the abovementioned technology, such a method also requires a long waiting period.

To solve the abovementioned problems, the present invention proposes a novel circuit for eliminating speaker crackle during turning on or off a power amplifier, wherein a charging voltage is used as an input signal, and whereby speaker crackle can be reduced without the penalty of bandwidth.

### SUMMARY OF THE INVENTION

The primary objective of the present invention is to provide a circuit for eliminating speaker crackle during turning on or off power amplifier and a method for the same, particularly a circuit and method, wherein a charging voltage of an input capacitor is used as an input signal to smooth pre-charge an output capacitor to reduce speaker crackle to an inaudible level during turning on or off a power amplifier.

The circuit of the present invention comprises: a control unit, at least one switch, an amplifier and a low pass LC filter. The control unit detects the power supply voltage to determine actions and sends control signals to the switches and the amplifier according to circuit requirements. The switches receive the control signals to control the charging and discharging of the capacitors inside the circuit. The amplifier amplifies input signals or input voltage and outputs the amplified signals to the low pass LC filter. The filtered signals are sent to a speaker device. When the circuit is turned on, the control unit sends a control signal to the switch to let an input capacitor Cin begin to be charged. The charging signal is directly amplified to drive the speaker device. The charging voltage for the input capacitor is a gradually rising voltage, and the time constant is (Rs+Rin)×Cin. After being amplified by the amplifier, the gradually rising voltage becomes a gradually rising output voltage. The gradually rising output voltage smooth charges an output capacitor Cout. Thus, the smooth charging replaces a high-peak pre-charging, wherein Iₚₑₐₖ=Vcc/R. Then, the turn-on crackle is reduced. When the control unit detects a turn-off signal, the capacitor, which has been charged, is discharged by the discharge circuit inside the amplifier and then standby for a smooth charging in the next starting.

In the case of an input resistor with 20K ohm, which is a typical value for most audio amplifiers, and an input capacitor with 1 uF, the −3 db frequency of the input circuit is 1/(2π×20 k×1 u)=8 Hz. In other words, only a small capacitor of 1 uF is enough to achieve an 8 Hz low frequency bandwidth. Generally, the frequency response of a speaker or the audition range of human ears is above 20 Hz. If the charging rate of the output capacitor is smaller than that a speaker can present or human ears can sense, no crackle can be perceived by users. Therefore, if a charging voltage is generated at a bandwidth of 8 Hz, the charging will not create audible crackle. Additionally, in such a charging method, musical signal can also be input even though the capacitors have not been charged to a pre-determined voltage. The charging curve of the input circuit is expressed by

V=V_{cc}/2(1−e^{-t/RinCin})

Let Rin=20 k ohms and Cin=1 uF. Thus, the charging voltage at Vcc=5 volts is

$$\begin{matrix}V = 5 / 2 ( 1 - {e}^{- t / 20 kx 1 u} ) \\ = 2.5 ( 1 - {e}^{- t / 20 m} )\end{matrix}$$

If the capacitor is charged to have a voltage of 99% Vcc,

5/2×99%=5/2(1−e^{-t/20 m}), and

0.99=1−e^{-t/20 m}.

In other words,

$$\begin{matrix}t = - 20 m \times ln 0.01 \\ = 0.092 seconds .\end{matrix}$$

In such a case, the difference between the charging voltage and Vcc/2 is

5V/2−5V/2×99%=0.025V.

Ordinarily, the voltage gain of a power amplifier is about 10×. Thus, 0.025V will be amplified into 0.25V. This small voltage is added upon music signal and it continues to reduce to zero voltage slowly. therefore, the quality of the music will not be affected at all. In the present invention, the waiting time is only 0.1 second and no second crackle is occurred.

Below, the embodiments of the present invention are described in detail in cooperation with the attached drawings to make easily understood the objectives, technical contents, characteristics and accomplishments of the present invention.

### BRIEF DESCRIPTION OF THE DRAWINGS

FIG. 1 is a diagram schematically showing a circuit of a conventional technology;

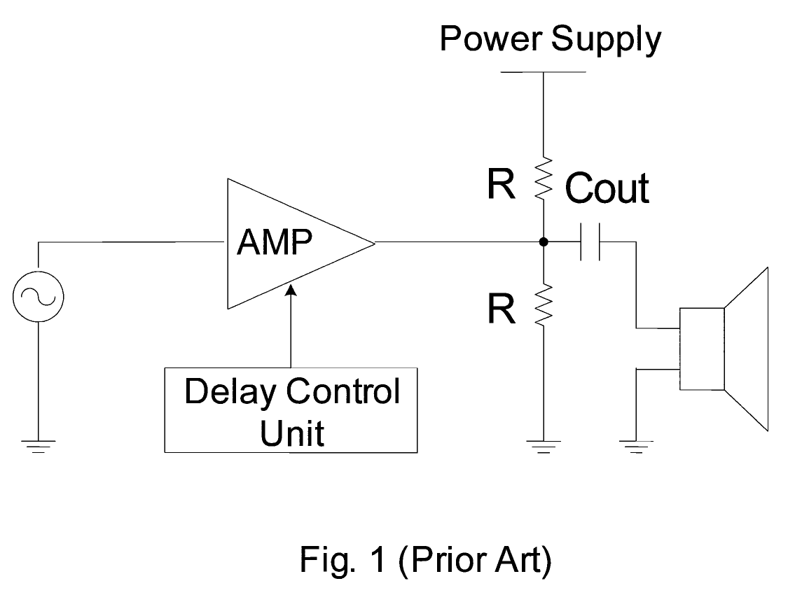

FIG. 2 is a diagram schematically showing a circuit of another conventional technology;

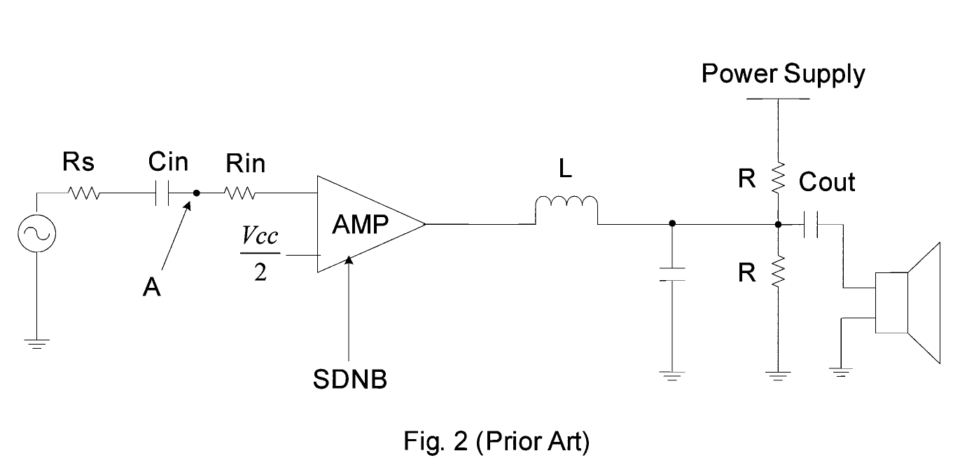

FIG. 3 is a diagram schematically showing a circuit according to the present invention; and

FIG. 4 is a timing diagram of a circuit according to the present invention.

### DETAILED DESCRIPTION OF THE INVENTION

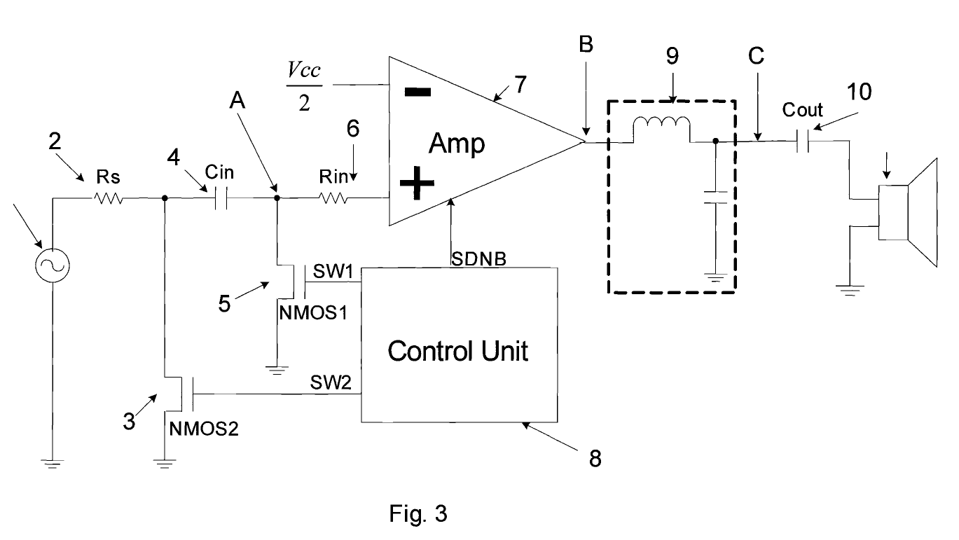

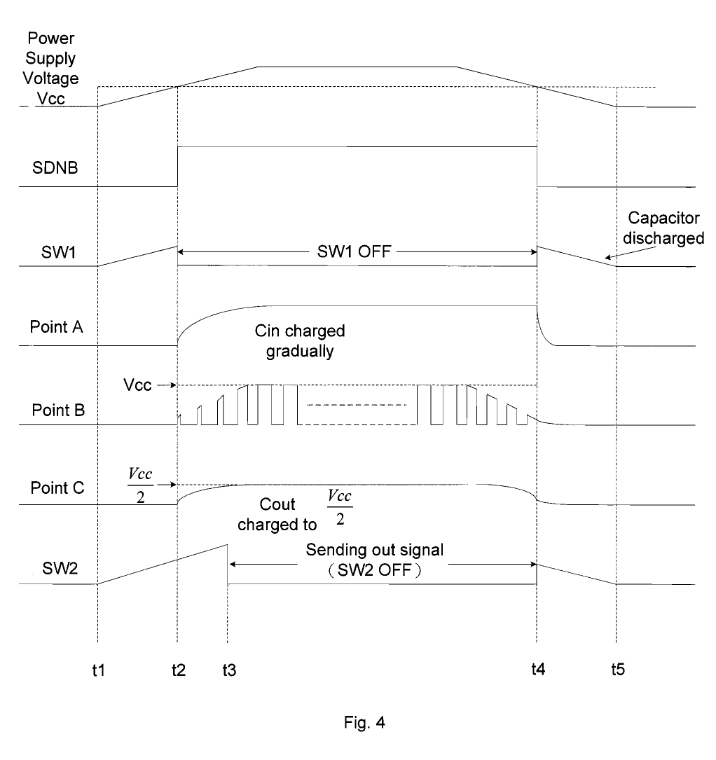

The present invention proposes a circuit for eliminating speaker crackle during turning on or off a power amplifier and a method for the same, wherein a charging voltage of an input capacitor is used as an input signal to smooth pre-charge an output capacitor to reduce speaker crackle to an inaudible level. Please refer to FIG. 3 for a circuit according to the present invention. The output terminal of a signal source 1 has a signal source resistor Rs 2. The signal source resistor Rs 2 is coupled to a switch transistor NMOS2 3 and an input capacitor Cin 4. One terminal of the switch transistor NMOS2 3 is coupled to the system ground; therefore, when the switch transistor NMOS2 3 is turned on, the input signal is short-circuited to the system ground. Thus a speaker 11 does not receive any input signal. The input capacitor Cin 4 is coupled to a switch transistor NMOS1 5 and an input resistor Rin 6. One terminal of the switch transistor NMOS1 5 is also coupled to the system ground; therefore, when the switch transistor NMOS1 5 is turned on, the voltage of the input capacitor Cin 4 is also short-circuited to the system ground. The input resistor Rin 6 is coupled to the input terminal of an amplifier 7. Both the switch transistors NMOS2 3 and NMOS1 5 are metal oxide semiconductors. The switch transistor NMOS2 3, the switch transistor NMOS1 5 and the amplifier 7 are coupled to a control unit 8. The control unit 8 detects the voltage of the power supply to determine actions and sends control signals to control the switch transistor NMOS2 3, the switch transistor NMOS1 5 and the amplifier 7. The output terminal of the amplifier 7 is coupled to a low pass LC filter 9. The output terminal of the Low pass LC filter 9 is coupled to an output capacitor Cout 10. The output capacitor Cout 10 is coupled to a speaker device 11. To make the present invention easily understood, the present invention will be demonstrated with the voltage variations at Point A behind the input capacitor Cin 4, Point B at the output terminal of the amplifier 7 and Point C at the output terminal of the low pass filter 9. Please refer to FIG. 4 for a timing diagram of the circuit shown in FIG. 3. Before the power supply is turned on, all signals are at a ground voltage. During the rising stage of the power supply voltage Vcc, i.e., during t1-t2, the voltages of control signals SW1 and SW2 also rise with the power supply voltage. Thus, the switch transistors NMOS2 3 and NMOS1 5 are at a turn-on state, and both ends of the input capacitor Cin 4 is at the ground voltage. When the power supply voltage Vcc rises to a given value at t2, SDNB signal is shifted from the ground voltage to a high level voltage and turns on the amplifier 7. At the same time, the control signal SW1 is shifted to the ground voltage and turns off the switch transistor NMOS1 5. Thus, the internal voltage of the amplifier 7 charges the input capacitor Cin 4 via the input resistor Rin 6, and the voltage variation at Point A is shown in FIG. 4. The amplifier 7 outputs PWM (Pulse Width Modulation) signals to Point B in response to the voltage of Point A. At this stage (t2 to t3), as the power supply voltage Vcc is still rising, the amplitudes of the PWM signals are also increasing. Further, the voltage of Point A is a gradually rising voltage and has a small duty cycle on the PWM signals or the PWM has small pulse width. These two factors result in that the PWM signals at Point B have gradually rising amplitude and gradually increasing pulse widths. After passing through the low pass LC filter 9, the signals of Point B become the signal of Point C, which is a gradually rising voltage signal and used to charge the output capacitor Cout 10. After the charging is completed at t3, the control signal SW2 is shifted from a high level voltage to the ground voltage and turns off the switch transistor NMOS2 3. Thus, the signals of the signal source 1 are transmitted to the amplifier 7 via the signal source resistor Rs 2 and the input resistor Rin 6. At this stage, the entire circuit enters a normal operation state. As shown in FIG. 4, the timing t3 does not necessarily coincide with the timing that the charging voltage of Point A has become stable.

When the power supply is turned off, the power supply voltage Vcc begins to descend at the same time as from t4 to t5, the amplifier 7 is driven by a lower working voltage and outputs signals with lower amplitudes at Point B. Thus, the voltage of Point C behind the low pass LC filter 9 is also decreasing. When the power supply voltage Vcc descends to a given value at t4, the SDNB signal is shifted from a high level voltage to a low level voltage to turn off the amplifier 7 and start the internal discharge circuit of the amplifier 7. Then, Point B is discharged by the internal discharge circuit of the amplifier 7. At the same time, the control signal SW2 is shifted from a low level voltage to a high level voltage to turn on the switch transistor NMOS2 3 and short-circuit the signals of the signal source 1 to the system ground via the signal source resistor Rs 2. Thus, the input signal is no more transmitted to the amplifier 7. At this stage, the power supply voltage Vcc has been a low voltage. Thus, the discharging current at Point B or Point C also becomes relatively smaller, and the speaker It will not generate turn-off crackle. At the same timing t4, the control signal SW1 is also shifted from a low level voltage to a high level voltage and turns on the switch transistor NMOS1 5. Thus, Point A is rapidly discharged to the ground voltage for the next starting up. The turn-on of the switch transistor NMOS1 5 results in that a low voltage is input to the amplifier 7. However, the amplifier 7 has been closed at this time. Thus, the speaker 11 cannot generate crackle any more. At t5, the entire circuit is restored to the system ground and standby for restart.

A class D power amplifier is used to exemplify the amplifier in the above description. However, the same principle can also apply to other types of power amplifiers, such as a class AB power amplifier.

Those described above are only the preferred embodiments to exemplify the present invention but not to limit the scope of the present invention. Any equivalent modification or variation according to the shapes, structures, features and spirit disclosed in the specification is to be also included within the scope of the present invention.

What is claimed is:

1. A circuit for eliminating speaker crackle during turning on or off a power amplifier comprising:
a control unit detecting a power supply voltage to determine actions and sending control signals according to circuit requirements;
a first switch receiving said control signals and controlling charging and discharging of capacitors inside said circuit;
an amplifier amplifying input signals; and
a low pass filter averaging signals or voltage output by said amplifier and transmitting filtered signals to a speaker device.

2. A circuit for eliminating speaker crackle during turning on or off a power amplifier according to claim 1, wherein said capacitors include an input capacitor and an output capacitor.

3. A circuit for eliminating speaker crackle during turning on or off a power amplifier according to claim 2, wherein when said power amplifier is being turned on, said first switch operates to let said input capacitor be charged; said amplifier amplifies a voltage of said input capacitor to pre-charge said output capacitor.

4. A circuit for eliminating speaker crackle during turning on or off a power amplifier according to claim 2 further comprising a second switch receiving said control signals and responsible for turning on or off signals of an audio signal source of said circuit.

5. A circuit for eliminating speaker crackle during turning on or off a power amplifier according to claim 4, wherein when said power amplifier is being turned off, said second switch disconnects signals of said audio signal source, and said first switch operates to let said input capacitor be discharged; then, said amplifier is closed, and a discharge circuit discharges said output capacitor.

6. A circuit for eliminating speaker crackle during turning on or off a power amplifier according to claim 1, wherein said first switch is a metal oxide semiconductor.

7. A circuit for eliminating speaker crackle during turning on or off a power amplifier according to claim 4, wherein said second switch is a metal oxide semiconductor.

8. A method for eliminating speaker crackle during turning on or off a power amplifier comprising:
utilizing a control unit to control at least one switch, wherein at least one said switch is used to control charging and discharging of capacitors of a circuit; and
on turning on a power amplifier of said circuit, said capacitor, which is being charged, performing pre-charging to drive a speaker; on turning off said power amplifier, discharging said capacitor, which has been charged, to a ground voltage.

9. A method for eliminating speaker crackle during turning on or off a power amplifier according to claim 8, wherein said control unit control said switches via sending control signals to said switches.

10. A method for eliminating speaker crackle during turning on or off a power amplifier according to claim 8, wherein said control unit determines actions via detecting a power supply voltage.

11. A method for eliminating speaker crackle during turning on or off a power amplifier according to claim 8 further comprising installing a switch to turn on or off a signal source of said circuit.

12. A method for eliminating speaker crackle during turning on or off a power amplifier according to claim 8, wherein said capacitors include an input capacitor and an output capacitor.
